(19) United States
(12) Patent Application Publication
(10) Pub. No.: US 2017/0339932 A1
(43) Pub. Date: Nov. 30, 2017

(54) FISH CAPTURE DEVICE WITH RELEASE MECHANISM

(71) Applicant: Joseph Anthony Curcio, Gray, ME (US)

(72) Inventor: Joseph Anthony Curcio, Gray, ME (US)

(21) Appl. No.: 15/446,037

(22) Filed: Mar. 1, 2017

Related U.S. Application Data
(60) Provisional application No. 62/307,711, filed on Mar. 14, 2016.

(51) Int. Cl. A01K 85/00; A01K 83/00; A01K 74/00

(52) U.S. Cl. CPC A01K 85/005; A01K 74/00; A01K 83/00

(57) ABSTRACT

A fish capture device comprises a reconfigurable member having at least one of a changeable size and a changeable shape when engaged within an inside of a mouth of a fish to retain the fish on the fish capture device. A trigger member triggers said at least one changeable size and changeable shape of the reconfigurable member. A release member substantially restores the reconfigurable member to at least one of an initial size and an initial shape for releasing the fish from the fish capture device.

### RELATED APPLICATION

This application claims the priority of U.S. Provisional Application Ser. No. 62/307,711, filed Mar. 14, 2016, incorporated herewith in its entirety.

### FIELD OF THE INVENTION

The present invention relates generally to catching fish in a manner that allows safe and easy release of the fish with little or no harm to the fish.

### BACKGROUND OF THE INVENTION

Currently there are a number of solutions for catching fish with and without artificial baits and lures of numerous designs used in commercial and recreational fishing. The typical fish capture method associated with conventional rod and reel fishing techniques employs baits and lures and involves the use of a fish hook that is designed to capture and retain a fish by piercing the fish's lip with a sharp metal hook. With a growing interest in society to protect and preserve natural environments and ecosystems, recreational fishing and to some extent commercial fishing has become increasingly more prone to practicing “catch and release” fishing techniques with the intention of releasing fish back to the environment, unharmed. While the interest in “catch and release” has grown in popularity, the fundamental equipment has not changed. Some of the common “catch and release” solutions attempt to preserve fish health by simply removing or bending down the barbs on conventional hooks. While the goal of a traditional hooked lure is for the hook to only penetrate through the lip of a fish, often the hooks end up causing unintended harm because they are completely swallowed or penetrate through another part of the mouth causing catastrophic injuries to the eyes, throat or belly. These initial injuries, while not always immediately life threatening are often exacerbated when the angler must remove the hook, or even worse, leave the hook embedded in the fish prior to release.

In addition to the physical damage done by the hook, stress on the fish also plays an important role in a fish's ability to survive. The longer a fish is out of the water to remove a hook after being caught the higher the stress levels in the fish and the lower the chances are that the fish will survive. An August 2002 study (Howells, 2002) performed by the Texas Parks and Wildlife department found that 22% of largemouth bass caught and immediately released died within 72 hours. A mortality rate this high goes against the principles of making fishing a sustainable, environmentally friendly and humane pastime.

It would be desirable to have a more reliable, safe, easy to use, “catch and release” fish capturing device that is suitable to be used with conventional rod and reel fishing equipment and techniques. To truly meet the objectives of “catch and release” fishing practices, a system that does not cause undue harm to a fish in the form of piercing body parts, extended time out of the water and unintentional hook related damage is desirable. Two fundamental factors that serve to facilitate sustainable “catch and release” fishing techniques would include a mechanism or method for capturing a fish without inducing physical damage or harm to the fish, and a reliable and rapid method or mechanism for releasing the caught fish without requiring excessive time out of the water or inflicting additional harm or damage to the captured fish.

### OBJECTS OF THE INVENTION

Thus, it is an object of the present invention to provide a fish capture device with release mechanism that does not suffer from any of the problems or deficiencies associated with prior solutions.

It is still further an object of the present invention to provide a fish capture device that does not inflict physical damage to the fish being captured.

Further still, it is an object of the present invention to provide a fish capture device that does not use a hook to pierce any portion of the fish's body.

Further still, it is an object of the present invention to provide a fish capture device that provides a means for rapid, easy to operate, manual release of the captured fish from the capture device.

Further still, it is an object of the present invention to provide a fish capture device that may be used independently on traditional rod and reel fishing equipment, on a single fishing line, on a trolling line, or on any other sort of fishing line available.

Further still, it is an object of the present invention to provide a fish capture device that may be used in conjunction with conventional artificial lures, whereby this capture device is used in place of conventional barbed and barbless fish hooks.

Further still, it is an object of the present invention to provide a fish capture device that may be used in place of conventional fishing lures, whereby this fish capture device performs the function of the conventional lure in attracting fish, while also performing the function of securing the captured fish to the fishing line, serving the same function as the conventional fish hook, but without the necessity of penetrating any portion of the fish's body.

### SUMMARY OF THE INVENTION

The present invention advantageously addresses the aforementioned objects by providing a simple, safe and reliable means for catching and releasing fish without inflicting any harm to the fish. This is accomplished using a mechanism that secures a fish to a line through a mechanical engagement with the interior of a fish's mouth without piercing or puncturing any of the fish's flesh. Engagement is achieved through changes to the physical characteristics such as the size and/or shape and/or surface texture of the device. Once located within the fish's mouth and triggered by the action of ingestion into the fish's mouth, the device remains securely affixed until purposefully released by the angler upon landing the fish. The ability to manually reset the physical characteristics of the device is novel and useful in that it provides for a means for removing the device from the fish's mouth without inducing any physical harm to the fish. Further, the ability to reconfigure the device manually assures that the fish, once caught on the device, will be securely fastened to the fishing line until it is desired by the angler to facilitate release.

The present invention is a reconfigurable mechanism that changes physical size and shape once taken into the mouth by a fish. Once inside the mouth, a trigger mechanism is disturbed by the fish's mouth acting on the device and the overall geometry of the device changes, making it difficult or impossible for the fish to spit out. Securely lodged within the mouth, this device provides sufficient strength to allow retrieval of the fish using conventional rod and reel equipment. Once “landed” ashore, the angler is able to rapidly release the fish by restoring the physical characteristics of the capture device, allowing easy removal from the fish's mouth.

In accordance with an aspect of the invention, fish capture device comprises a reconfigurable member having at least one of a changeable size and a changeable shape when engaged within an inside of a mouth of a fish to retain the fish on the fish capture device. A trigger member triggers said at least one changeable size and changeable shape of the reconfigurable member. A release member substantially restores the reconfigurable member to at least one of an initial size and an initial shape for releasing the fish from the fish capture device.

The reconfigurable member may comprise a compliant spherical body having concentric solid and hollow rods for elongating the spherical body in response to said triggering and for shrinking the spherical body in response to said releasing. The reconfigurable member may comprise a hinged member pivotally supported on a shaft. The reconfigurable member may comprise a wound linear spring. The reconfigurable member may comprise a shaft and a plurality of arms hingeably fixed on an end of the shaft.

The trigger member may include a trigger element triggerable by compression from the mouth of the fish on the trigger element. The release member may comprise a user-activatable release element for substantially restoring the reconfigurable member to said at least one of the initial size and the initial shape. An action of a mouth of the fish closing on the fish capture device may cause said triggering of said at least one changeable size and changeable shape of the reconfigurable member. The entire reconfigurable member may be disposable within the mouth of the first prior to said triggering.

### BRIEF DESCRIPTION OF THE DRAWINGS

The present invention is a fish capture device to be used with conventional rod and reel fishing equipment, that catches fish without the use of conventional fishhooks, assuring the safest, non-detrimental means of achieving reliable “catch and release” fishing capability. More specifically, the present invention allows for a means for capturing fish through a purely mechanical engagement between the device and the interior of a fish's mouth without any portion of the fish's body being pierced or penetrated as is typically the case when using fish hooks. The present invention uses reconfigurable physical characteristics to engage the mechanism with the fish's mouth and employs a mechanism to allow manual release of the device from the fish in order to facilitate rapid and safe release of the fish from the device. The present invention is intended to be used as a stand-alone capture device in place of conventional fishing lures, and/or to be used in conjunction with conventional lures and other conventional fishing tackle commonly employed by anglers worldwide. Several embodiments of the invention are described herein, all consisting of core components including a reconfigurable capture mechanism, a central structure with eyelet for attaching to fishing line or other conventional tackle, a trigger mechanism and a release mechanism.

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 shows the hinged “umbrella” or “Christmas tree” design device that uses a series of hinged arms attached in either a single row or multiple rows radially positioned around a central shaft.

FIG. 2 shows the compliant spherical “ball-like” design device that uses concentric solid and hollow rods to elongate or shrink the spherical ball structure, causing a widening and narrowing of the girth of the ball component.

FIG. 3 shows the hinged “anchor” style design device that uses a simple “open/closed book” style mechanism for providing an anchoring structure to assure physical contact with the interior regions of a fish's mouth.

FIG. 4 shows the “pivoting arm” style design device that uses a simple “T” shaped scissoring mechanism to assure physical contact with the interior regions of a fish's mouth.

FIG. 5 shows a “linear spring” style design device that employs the natural tendency of linear spring material to curl up when depressed orthogonally to the main axis of the material. Oriented in such a way that two or more parallel positioned lengths of this material will curl in directions away from a central shaft, this device will grow radially once triggered.

FIG. 6 shows an “inverted umbrella” design that operates in a manner similar to a common umbrella once inverted. Hinged arms held in place by a triggering mechanism and forced outward by a spring, cause this device to grow radially once triggered.

### DETAILED DESCRIPTION OF THE PREFERRED EMBODIMENTS

The present invention is directed to provide a fish capture device with release mechanism that allows for the safe and effective capture of fish without piercing any portion of the fish's body.

The intent of this device is to provide a secure means for capturing fish using what is commonly understood to be conventional rod and reel fishing equipment. As such, this device is intended to be attached to a fishing line and deployed by casting the line using a rod and reel system, hand-line or any other normal and conventional means for capturing fish. The device is unique from common fishing hooks in that it does not rely on a sharp point to pierce through the flesh of a fish, but rather on reconfiguration of physical characteristics causing the device to be difficult or impossible for a fish to dislodge from within the fish's mouth once ingested, in order to assure capture. In addition to the unique physical reconfiguration technique used for assuring safe and harmless capture, the device consists of a means for configuring the physical characteristics to a state that allows easy removal from the fish's mouth to facilitate safe and harmless release of the fish by the angler.

In its most complete version, the present invention is made up of the following components; a central structural rod with eyelet, a trigger mechanism, a reconfigurable capture mechanism and a release mechanism. These components are connected and related to one another as follows: The central rod with eyelet is used to attach the device to a conventional fishing line, snap, swivel or other component of fishing tackle and provides a central structure for the device. The trigger mechanism allows the reconfigurable capture mechanism to be maintained in a “cocked” position until a fish has ingested the device. The reconfigurable capture mechanism allows for a size, shape, texture or other physical characteristic that is readily ingested by a fish and facilitates capture of the fish through change in that physical characteristic, by engaging mechanically with the interior of the fish's mouth. The release mechanism allows for manual actuation of the reconfigurable capture mechanism, either restoring the capture mechanism back to a pre-triggered condition, or to a unique release condition, with either condition suitable for safe and harmless release of the device from the fish's mouth without injury or delay. Minor mechanical components including but not limited to springs, pins, bushings, rods, bearings, latches, plates and fasteners are used in the fabrication of the device. These minor components are not described in intimate detail in this set of descriptions, but are referenced as relevant to the function of the device and included in the accompanying diagrams. Several example embodiments are shown in figure form and described in detail.

It is recognized that all of these depictions are shown and described as useful in their bare form (as shown) as a direct replacement to the common and standard fish hook and/or as a component of a fishing lure. Also, it is understood that each of these embodiments could be covered with a compliant membrane material decorated and adorned as part of a fishing lure design, improving the attraction to fish and improving the overall performance as a hook-less fish capture device.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

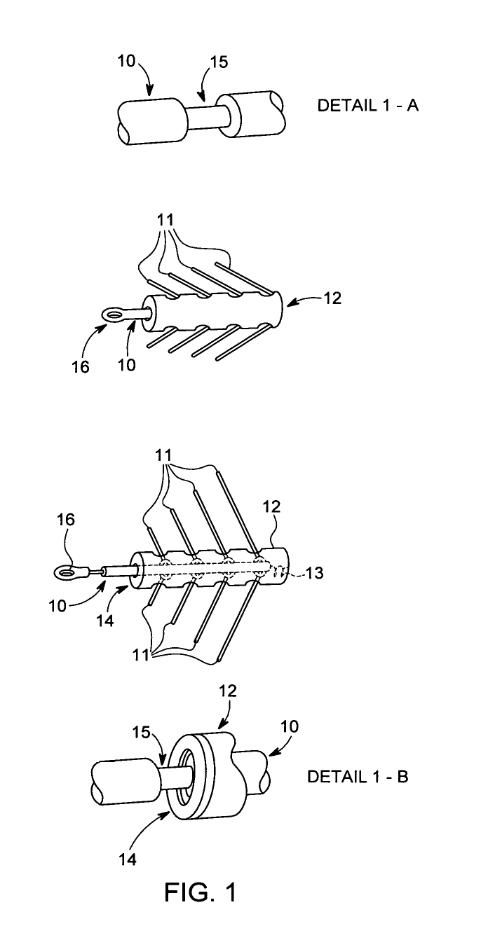

One method for providing the function of reconfiguring the size and shape of the device includes an expanding frame structure depicted in FIG. 1 (depicted as “Umbrella” or “Christmas Tree” style design). A central solid rod (10) is attached to several hinged arms (11) controlled by the movement of a hollow rod (12) moving axially relative to the central rod (10), causing the hinged arms to expand radially. A spring (13) acting at the end of the solid rod (10) pushing against the closed end of the hollow rod (12) assists in holding the hinged arms (11) in their outward position. A hole in pivot plate (14) aligns with a detent feature (15) on the solid central rod (10) and provides a feature to lock the hollow rod (13) in the “cocked” or “ready” position. By manually shifting the hollow rod (12) assembly slightly “off axis” from the solid rod (10), an edge of the hole in the pivot plate (14) will lodge or catch against a shoulder in the detent feature (detail 1-A) of the solid rod (10), holding the mechanism in the “cocked” position with the spring (13) compressed as depicted in detail 1-B. The action of the fish's mouth closing on the device causes the central hole in the pivot plate (14) to become dislodged from the edge of the detent in the central solid rod (10), resulting in the spring pushing the end of the solid rod (10) away from the closed end of the hollow rod (12) axially and actuating the hinged arms (11) outward. The central solid rod (10) also provides an eye (16) that allows attachment to a fishing line or other fishing device such as a conventional lure. Tension produced by reeling in on the fishing line acts on the central solid rod (10) and eye (16) and acts to further embed the device within a fish's mouth by continually pushing the hinged arms (11) outward and into contact with the interior of the fish's mouth. Manually pulling the hollow rod assembly (12) back in the direction of the eye (16) in the solid rod (10) compresses the spring (13) and retracts the hinged arms (11) causing a narrowing of the entire assembly for release and removal from the fish's mouth. A compliant (soft rubber or other similar material) covering (not shown in diagram) may be included with device in order to provide a more streamlined and ergonomically compliant physical shape to the device. This outer, compliant membrane covering may be adorned with graphics and coloring in order to mimic bait and/or otherwise improve attraction to fish as a lure.

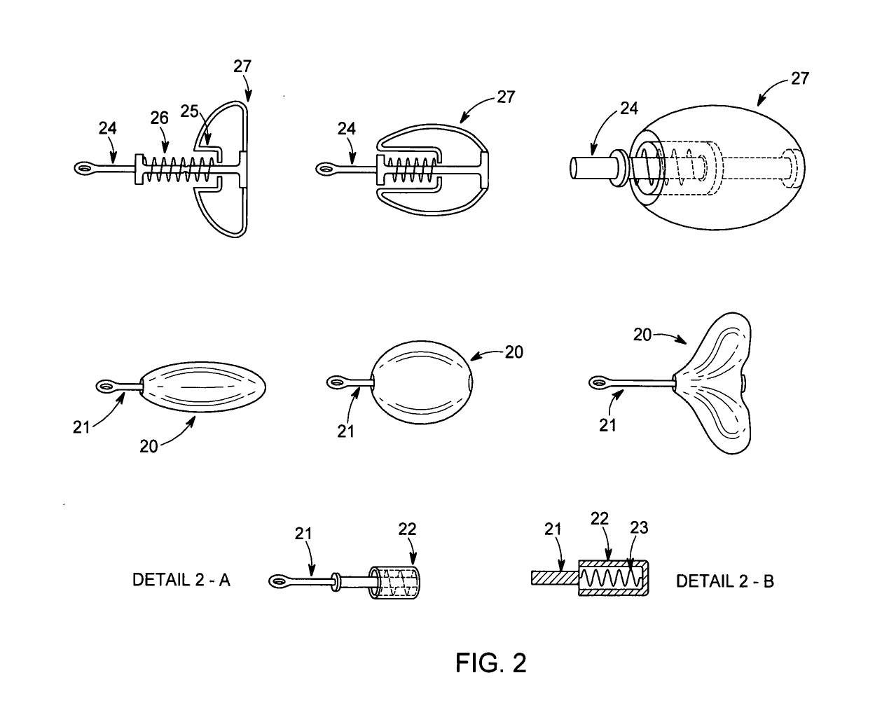

In another embodiment of the invention as shown in FIG. 2 (depicted as “Spherical ball-like” design), a ball-like, compliant spherical component (20) is held in a narrow, elongated configuration by a solid rod (21) inside a hollow rod (22) running through the middle of the sphere. At one of the two penetrations through the sphere, the hollow rod (22) is connected to the spherical component and at the other penetration through the sphere (20), the solid rod (21) is connected to the spherical component. In this manner, relative axial motion between the solid rod (21) and the hollow rod (22) causes the compliant spherical object (20) to elongate along the rods' axis and narrow or neck down along the transverse axis. A spring (23) acts to retract the solid rod (21) relative to the hollow rod (22), causing the compliant spherical device to tend to remain in the widest condition as measured transverse to the solid rod (21) and hollow rod (22) axis.

Solid rod (21) and hollow rod (22) are held in the “closed” or “cocked” position by manually positioning the end of solid rod (21) so that it rests against a notch at the open end of the hollow rod (22) and remains held in place due to tension created by the stretched spring (23). Triggering is caused by pushing the solid rod (21) off of the notch on the open end of the hollow rod (22) as initiated by the forces of the fish's mouth closing on the exterior of the device. Once triggered, the solid rod (21) is pulled into the hollow rod (22) by the retracting spring (23) causing the exterior membrane to bellow outwards as depicted in the “open” position image. Release of the device from the fish's mouth is accomplished by manually pulling the solid rod (21) outward from the hollow rod (22) thereby elongating the outer membrane as shown in the “closed” or “cocked” position as shown in the FIG. 2.

An alternate mechanism for actuating the spherical or “ball-like” design is shown in FIG. 2, “alternate mechanism”. In this instance, a central solid rod (24) acts against a hollow tube (25) to extend and retract opposite ends of a compliant membrane (27) causing the membrane to transition in overall shape from an elongated shape to a broad (wide) shape as indicted in FIG. 2. A triggering mechanism consisting of a detent feature in the solid rod (24) that engages through slight axial misalignment between the solid rod (24) and a hole in the closed end of the hollow tube (25). The compressed spring provides the axial force that holds the device in the “cocked” position and is actuated by the action of a fish's mouth pushing sideways against the elongated ball member, dis-lodging the engagement between the shoulder of the end plate hole pressing against the detent feature in the solid rod (24). Spring force retains the spherical object in the shortened (as measured along the solid rod (24) and hollow tube (25) axis) configuration. Manually pushing against the spring allows the solid rod (24) to lengthen along the hollow tube (25) axis and reduce the transverse size of the compliant spherical object, allowing easy removal from the fish's mouth.

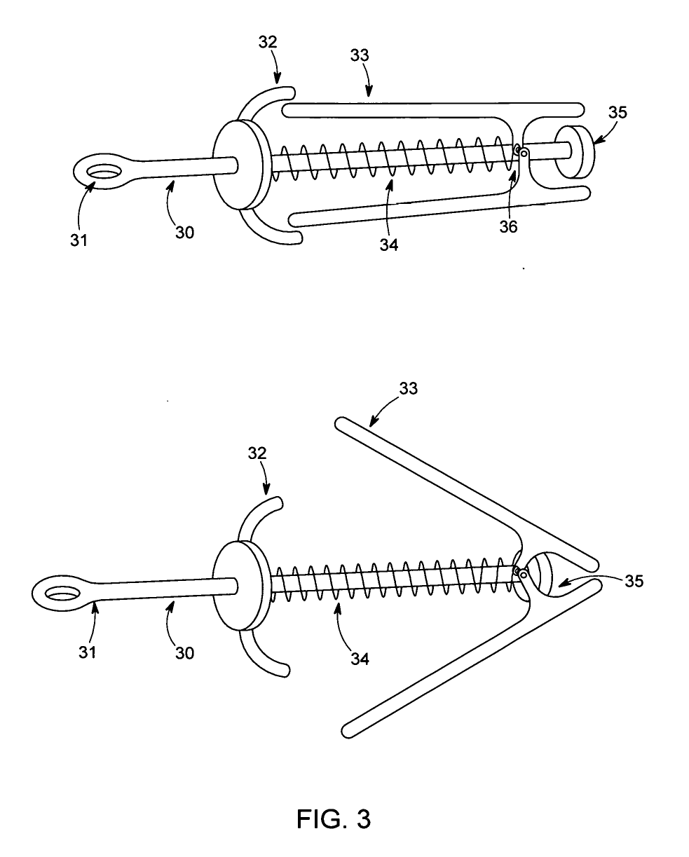

In another embodiment of the invention as depicted in FIG. 3 (“Anchor style” design), a hinged mechanism unfolds in order to act like an anchor securing the device within the fish's mouth. A center shaft (30) with eye (31) secures the device to the fishing line and provides the central structure for the hinged elements (33) which will fold outwards when deployed within the fish's mouth. A spring (36) provides the force necessary for extending the hinged elements (33) and a trigger release (32) acting against a compressed spring (34) is used to keep the hinged elements (33) closed until deployed. The trigger mechanism is set so that the ears on a washer-like plate, secured in place on center shaft (30) retain the ends of the hinged elements (33) loosely. Disturbance to the plate (32) caused by the action of a fish striking the lure, causes the plate (32) to move out of alignment with the ends of the hinged elements (33). Once disturbed, the ends of hinged elements (33) are free to swing open as depicted in FIG. 3. A sliding piston head (35) positioned at the end of the center shaft (30) is used to manually retract the hinged elements (33) by forcing the distal end of the hinged elements apart and causing the proximal ends of the hinged elements to close into alignment with the solid shaft (30) for removal from the fish's mouth for release. A compliant membrane (not shown) may cover the mechanism, providing a softer, more streamlined surface. This membrane may be decoratively painted and adorned in order to resemble a particular fish species, or in general to be more attractive as food to the fish being sought for capture.

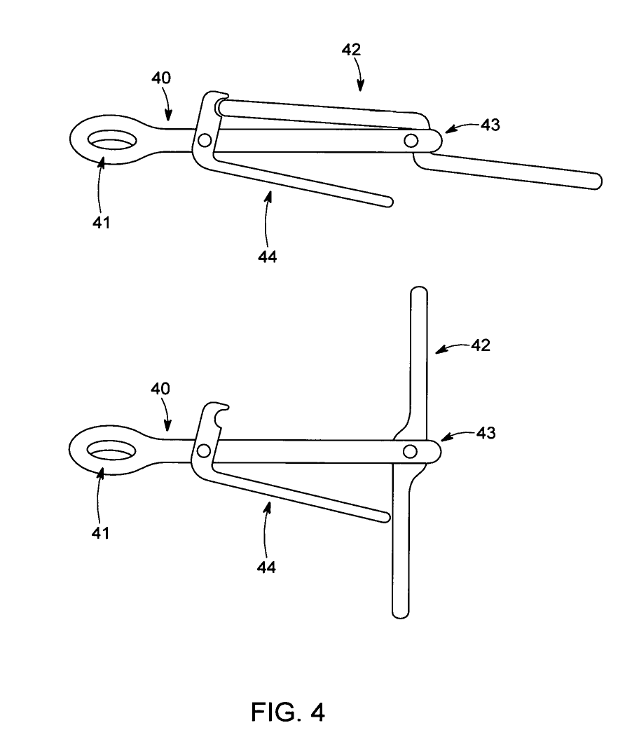

In another embodiment of the invention as shown in FIG. 4 (depicted “Pivoting Arm” style design), a central rod (40) with eye (41) provides for a means to attach the device to fishing line and provides a central structure for the device. A pivoting anchor arm (42) attached to the central rod (40) is affixed in such a way that upon release from a retaining trigger mechanism (44), the rod will toggle away from a position parallel to the central rod (40) to a position that is perpendicular to the central rod (40), driven by spring (43). Triggering is caused by the action and forces generated from closure within a fish's mouth, disturbing the trigger mechanism (44), causing release of the tip of anchor arm (42). In the “open” position, it will be difficult or impossible for the captured fish to spit the device out of the fish's mouth, and in this position, the device will provide a secure, yet non-penetrating method for capturing and reeling in the fish. The device may be reset for easy and safe removal from the fish's mouth by pushing down on the reset bar (integral to trigger mechanism) (44) acting on the pivoting anchor arm (42) in a way that causes the pivoting anchor arm (42) to re-align into a parallel position with the central rod (40).

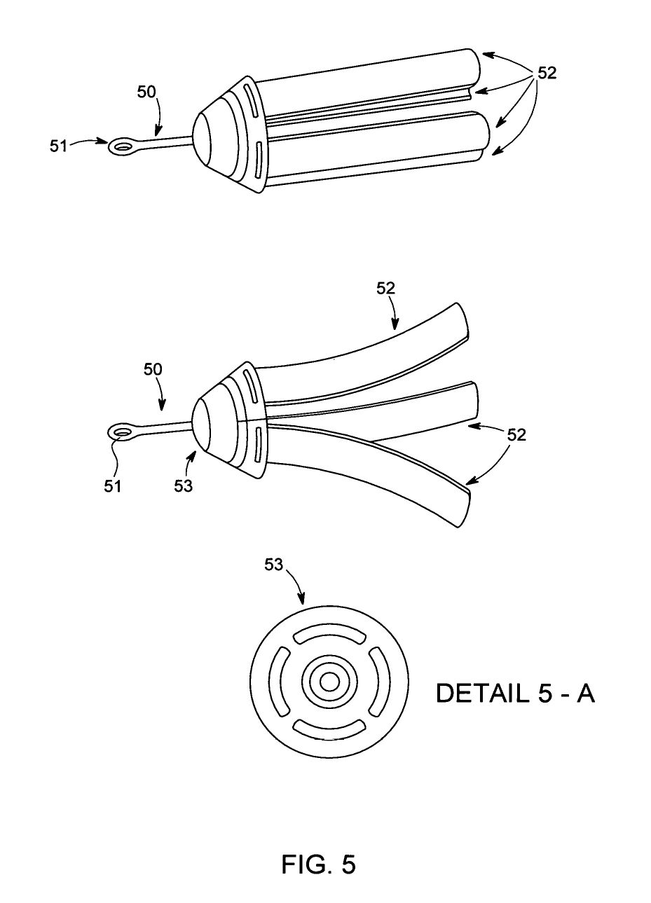

In another embodiment of the invention as shown in FIG. 5 (depicted as “Linear Spring” style design), a series of spring material curved “blade-like” arms (52) are set in a parallel arrangement around a central shaft (50) outfitted with an integral eye (51) for attaching the device to fishing line or tackle. The material used for the “blade-like” arms (52), when disturbed will tend to curl up (as is common with “linear spring” material as used in tape measures and “snap bracelets” and other devices). Having these “blade-like” arms arranged so that the curling action is directed away from the central shaft makes it so that this device will become difficult to dislodge from a fish's mouth once triggered. Removal is accomplished by sliding a plate like ring (53) as shown in detail 5-A, outfitted with slots that conform to the “blade-like” arms, down along the “blade-like” arms (52) to restore them to the original parallel arrangement.

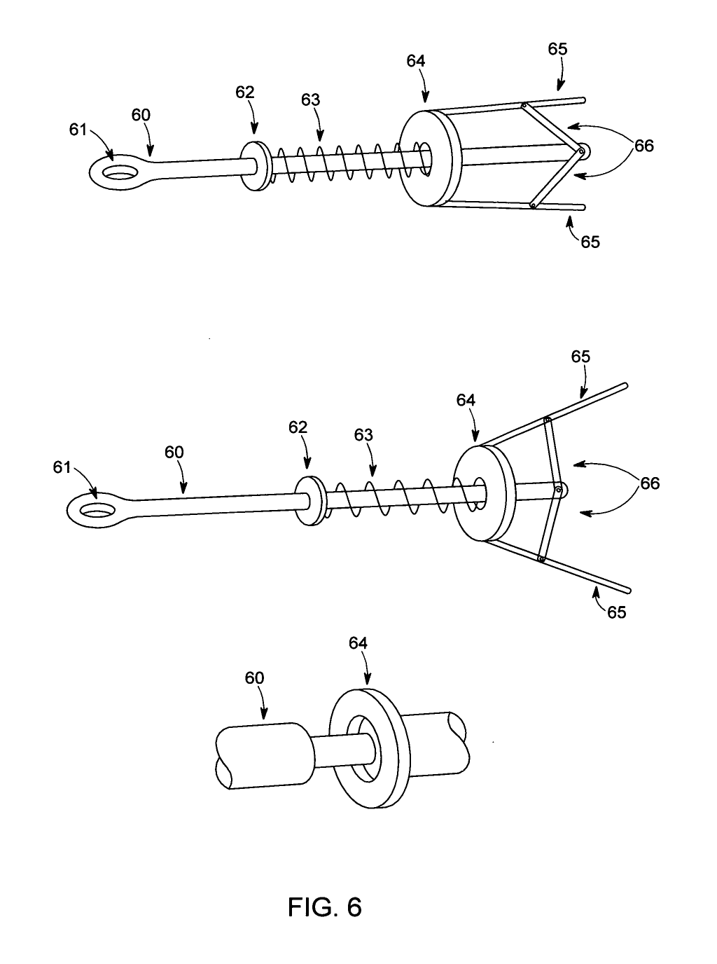

In another embodiment of the invention as shown in FIG. 6 (depicted as “Inverted Umbrella” style design), a central shaft (60) equipped with an integral eye (61) provides the central structure and attachment to a series of hinged arms (65). A spring (63) is compressed and acting against a boss-like feature (62) on the central shaft (60) provides the force to release the hinged arms (65) from a retracted (“cocked” or “loaded”) position parallel to the central shaft (60) once triggered, causing the hinged arms (65) to swing outward radially, guided by lever arms (66) pivoting off of the central shaft (60). A central hole in a washer-like plate (64) engages with a detent in the central shaft (60) holding the mechanism in the “loaded” position until triggered. The device is reset and removed from the fish's mouth by pulling the washer-like plate (64) and hinged arms (65) as an assembly outward along the central shaft (60) in the direction of the eye (61), causing the hinged arms (65) to return to the retracted position parallel to the central shaft (60).

### Modifications

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A fish capture device, comprising:
a reconfigurable member having at least one of a changeable size and a changeable shape when engaged within an inside of a mouth of a fish to retain the fish on the fish capture device.

2. A fish capture device according to claim 1, further comprising
a trigger member, for triggering said at least one changeable size and changeable shape of the reconfigurable member; and
a release member for substantially restoring the reconfigurable member to at least one of an initial size and an initial shape for releasing the fish from the fish capture device.

3. A fish capture device according to claim 1, wherein the reconfigurable member comprises a compliant spherical body having concentric solid and hollow rods for elongating the spherical body in response to said triggering and for shrinking the spherical body in response to said releasing.

4. A fish capture device according to claim 1, wherein the reconfigurable member comprises a hinged member pivotally supported on a shaft.

5. A fish capture device according to claim 1, wherein the reconfigurable member comprises a wound linear spring.

6. A fish capture device according to claim 1, wherein the reconfigurable member comprises a shaft and a plurality of arms hingeably fixed on an end of the shaft.

7. A fish capture device according to claim 2, wherein the trigger member includes a trigger element triggerable by compression from the mouth of the fish on the trigger element.

9. A fish capture device according to claim 2, wherein the release member comprises a user-activatable release element for substantially restoring the reconfigurable member to said at least one of the initial size and the initial shape.

10. A fish capture device according to claim 2, wherein an action of a mouth of the fish closing on the fish capture device causes said triggering of said at least one changeable size and changeable shape of the reconfigurable member.

11. A fish capture device according to claim 2, wherein the entire reconfigurable member is disposable within the mouth of the first prior to said triggering.

12. A fish capture device, comprising:
a reconfigurable member having a changeable shape when engaged within an inside of a mouth of a fish to retain the fish on the fish capture device.
a trigger member, for triggering said at least one changeable size and changeable shape of the reconfigurable member; and
a release member for substantially restoring the reconfigurable member to at least one of an initial size and an initial shape for releasing the fish from the fish capture device.

13. A fish capture device according to claim 12, wherein the reconfigurable member comprises one of a compliant spherical body having concentric solid and hollow rods for elongating the spherical body in response to said triggering and for shrinking the spherical body in response to said releasing, a hinged member pivotally supported on a shaft, a wound linear spring, and a shaft and a plurality of arms hingeably fixed on an end of the shaft.

14. A fish capture device according to claim 12, wherein the trigger member includes a trigger element triggerable by compression from the mouth of the fish on the trigger element.

15. A fish capture device according to claim 12, wherein an action of a mouth of the fish closing on the fish capture device causes said triggering of said at least one changeable size and changeable shape of the reconfigurable member.

16. A fish capture device according to claim 12, wherein the entire reconfigurable member is disposable within the mouth of the first prior to said triggering.

17. A fish capture device, comprising:
a reconfigurable member having a changeable size when engaged within an inside of a mouth of a fish to retain the fish on the fish capture device.
a trigger member, for triggering said at least one changeable size and changeable shape of the reconfigurable member; and
a release member for substantially restoring the reconfigurable member to at least one of an initial size and an initial shape for releasing the fish from the fish capture device.

18. A fish capture device according to claim 17, wherein the reconfigurable member comprises one of a compliant spherical body having concentric solid and hollow rods for elongating the spherical body in response to said triggering and for shrinking the spherical body in response to said releasing, a hinged member pivotally supported on a shaft, a wound linear spring, and a shaft and a plurality of arms hingeably fixed on an end of the shaft.

19. A fish capture device according to claim 17, wherein the trigger member includes a trigger element triggerable by compression from the mouth of the fish on the trigger element.

20. A fish capture device according to claim 17, wherein an action of a mouth of the fish closing on the fish capture device causes said triggering of said at least one changeable size and changeable shape of the reconfigurable member.
